(19) United States
(12) Patent Application Publication
(10) Pub. No.: US 2026/0203336 A1
(43) Pub. Date: Jul. 16, 2026

(54) SYSTEM AND METHOD FOR ANALYZING AND MANAGING TECHNICAL DOCUMENTS

(71) Applicant: SK hynix Inc., Gyeonggi-do (KR)

(72) Inventor: Siarhei ZALIVAKA, Gdansk (PL)

(21) Appl. No.: 19/026,145

(22) Filed: Jan. 16, 2025

(51) Int. Cl. G06F 16/35; G06F 40/194

(52) U.S. Cl. CPC G06F 16/35; G06F 40/194

(57) ABSTRACT

A system for managing a technical document for a storage device includes: a large language model (LLM) configured to receive parts selected from a first version of the technical document, which have a target characteristic, and a second version of the technical document newer than the first version of the technical document, and generate first vectors for the selected parts from the first version of the technical document and second vectors for all parts from the second version of the technical document based on semantics. A comparator compares each of the second vectors with the first vectors to find a closest first vector, and generates a similarity metric between each of the second vectors and the closest first vector. A classifier classifies each of the parts from the second version of the technical document based on the similarity metric and text values of the parts from the second version.

### BACKGROUND

### 1. Field

Embodiments of the present disclosure relate to management of a technical document for a storage device.

### 2. Description of the Related Art

The development of a storage device such as a solid state drive (SSD) is based on a large number of technical documents, which determine different aspects of the storage device. Non-limiting examples of the technical documents include standards documents such as low-power Mobile Industry Processor Interface (MIPI) Physical Layer (M-PHY) specifications, peripheral Component Interconnect Express (PCIe or PCI-e) Specifications, Joint Electronic Device Engineering Council (JEDEC) documents, Open NAND Flash Interface (ONFi) specifications, Non-Volatile Memory express (NVMe) specifications, etc. These technical documents are frequently updated (e.g., monthly, quarterly, yearly, or with another periodicity) in order to support more efficient standards requiring the best device performance.

Usually, significant updates of standards lead to the considerable amount of changes in texts of technical documents. In most cases, notable parts or contents (e.g., 30-70%) of a current version of a technical document associated with standard updates may be transferred to a new version of the technical document without changes or with insignificant changes, preserving the meaning of contents or texts. The new version of the technical document can be analyzed and evaluated through various approaches including manual efforts. It is in this context that embodiments of the invention arise.

### SUMMARY

Aspects of the present invention include a system and a method for analyzing and managing technical documents for a storage device based on large language models.

In one aspect of the present invention, a system for managing a technical document for a storage device includes: a large language model (LLM) configured to receive parts selected from a first version of the technical document, which have a target characteristic, and a second version of the technical document newer than the first version of the technical document, and generate first vectors for the selected parts from the first version of the technical document and second vectors for all parts from the second version of the technical document based on semantics; a comparator configured to compare each of the second vectors with the first vectors to find a closest first vector, and generate a similarity metric between each of the second vectors and the closest first vector; and a classifier configured to classify each of the parts from the second version of the technical document based on the similarity metric and text values of the parts from the second version.

In one aspect of the present invention, a method for managing a technical document for a storage device includes: generating first vectors for parts selected from a first version of the technical document, which have a target characteristic, and second vectors for all parts from a second version of the technical document based on semantics, the second version of the technical document newer than the first version of the technical document; comparing each of the second vectors with the first vectors to find a closest first vector; generating a similarity metric between each of the second vectors and the closest first vector; and classifying each of the parts from the second version of the technical document based on the similarity metric and text values of the parts from the second version.

Additional aspects of the present invention will become apparent from the following description.

### BRIEF DESCRIPTION OF THE DRAWINGS

FIG. 1 is a diagram illustrating a documents analysis system and a verification system in accordance with one embodiment of the present invention.

FIG. 2 is a diagram illustrating a technical document analysis system in accordance with one embodiment of the present invention.

FIG. 3 is a diagram of a neural network in accordance with one embodiment of the present invention.

FIG. 4 illustrates examples of results for M-PHY specification obtained by a technical document management method in accordance with one embodiment of the present invention.

FIG. 5 illustrates examples of the requirement with insignificant changes in accordance with one embodiment of the present invention.

FIG. 6 is a flowchart illustrating a method for managing a technical document in accordance with one embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of the embodiments of the present invention is provided below along with accompanying figures that illustrate aspects of the present invention. The present invention is described in connection with such embodiments, but the present invention is not limited to any embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention may not have been described in detail.

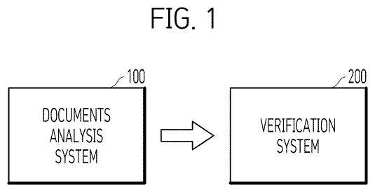

FIG. 1 is a diagram illustrating a documents analysis system 100 and a verification system 200 in accordance with one embodiment of the present invention.

Referring to FIG. 1, the documents analysis system 100 may analyze a technical document to be used for verifying a designed system (e.g., system on a chip (SoC)). In various embodiments, the designed system may be components of storage devices such as NAND flash memory devices, e.g., Solid State Drive (SSD), Embedded MultiMedia Card (eMMC), Open NAND Flash Interface (ONFi), Universal Flash Storage (UFS), a low-power Mobile Industry Processor Interface (MIPI) Physical Layer (M-PHY), Non-Volatile Memory express (NVMe), etc. In various embodiments, the technical document may include at least one of a specification (standards documents), a datasheet, a product manual, and a user guide for the storage devices above.

The documents analysis system 100 may provide the verification system 200 with the analysis result. The verification system 200 may receive the analysis result from the documents analysis system 100, and perform a verification process on the designed system based on the analysis result. The verification system 200 may verify whether the designed system meets the requirements described in a technical document for the designed system. The analysis results obtained from documents analysis system 100 may be also used by verification engineers in order to design verification system 200.

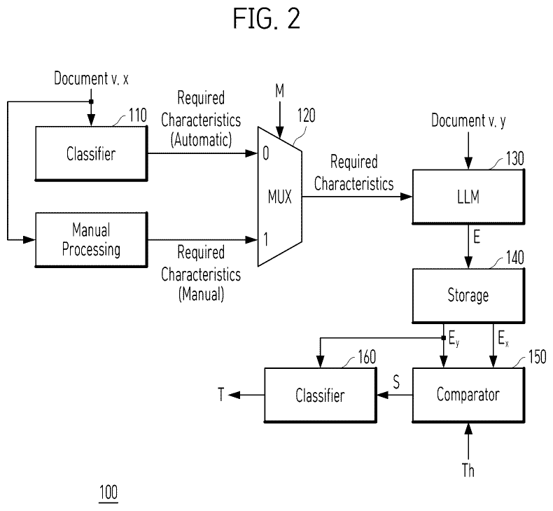

FIG. 2 is a diagram illustrating a technical document analysis system 100 in accordance with one embodiment of the present invention.

The documents analysis system 100 may provide a two-stage document analysis and management scheme. At the first stage, the documents analysis system 100 compares target (required) characteristics from an older version of a document with a newer version of the document and detects characteristics of the newer version of the document that have the same or slightly modified texts from the older version of the document based on a particular technique (e.g., sentence embeddings technique). At the second stage, the documents analysis system 100 analyzes the rest of the texts in the newer version of the document with a classifier to detect new required characteristics. In some embodiments, the required characteristics may include design requirements, algorithms, test sequences, important parameters, etc.

The documents analysis system 100 may consider two versions of a technical document: a first version of the document may be the older (previous) version of the document (i.e., Document v.x), and a second version of the document may be the newer version of the document (i.e., Document v.y).

For all the atomic parts (e.g., sentences, paragraphs, sections, chapters, etc.) from the old version marked as required characteristics, vectors (e.g., embedding vectors) may be computed and stored. After that, the whole content from the newer version may be also transformed into vectors. This representation allows comparing of the atomic parts from different versions of the document by its meaning (semantics) in a more precise way than in case of the full-text comparison. The required characteristics from the older version, having a certain amount of similarity (i.e., bigger than a threshold), may be considered as the characteristics inherited by the newer version of the document.

Atomic parts with lower similarity may be processed by a classifier to make a decision on whether these atomic parts have the required characteristic or not. As a result, the content of the newer version of the document may be classified into four types: 1) Type 0 (Class 0): the atomic parts having exact match with the previous version of the document, i.e., string content is the same; 2) Type 1 (Class 1): the atomic parts having good match with the previous version of the document, i.e., the similarity is greater than a certain threshold; 3) Type 2 (Class 2): the atomic parts classified as having the required characteristic, but were not in the previous version of the document; and 4) Type 3 (Class 3): the atomic parts having poor match with the previous version of the document and without required characteristic. The atomic parts of the first to three types may be more likely to have the required characteristic compared to the fourth type.

In the illustrated embodiment of FIG. 2 to achieve the two-stage document analysis and management scheme above, the documents analysis system 100 may include a classifier 110, a multiplexer (MUX) 120, a large language model (LLM) 130, a storage 140, a comparator 150 and a classifier 160. In some embodiments, the classifiers 110, 160 may be implemented with a machine language model or a large language model.

The classifier 110 may extract required characteristics from the older Document v. x. Alternatively, the required characteristics may be extracted by manually. The multiplexer 120 may select the required characteristics in response to a control signal M. For example, the multiplexer 120 may select the required characteristics with the pre-trained classifier 110 (M=0) or manually (M=1).

The LLM 130 may receive parts selected from the first version of the technical document, which have a target characteristic. Further, the LLM 130 may receive the second version of the technical document newer than the first version of the technical document. The LLM 130 may generate first vectors for the selected parts from the first version of the technical document, and second vectors for all parts from the second version of the technical document based on semantics. The storage 140 may store the first vectors and the second vectors.

In some embodiments, the LLM 130 may process the extracted characteristics through embeddings computation for each of the atomic parts associated with the extracted characteristics of the document v. x. Further, the LLM 130 may perform an embeddings computation for the document v. y content, i.e., the whole content, not only the required characteristics, as the required characteristics of the newer Document v. y are unknown and need to be recognized. As a result, the LLM 130 may generate embedding vectors (Eₓ) of the required characteristics from the older Document v. x, and may generate embedding vectors (E_{y}) of the atomic parts from the newer Document v. y. The storage 140 may store the embedding vectors (Eₓ) of the required characteristics from the older Document v. x and the embedding vectors (E_{y}) of the atomic parts from the newer Document v. y. In some embodiments, the storage 140 may be implemented with a vector database or an object storage.

Sentence embedding refers to a numeric representation of a sentence in the form of a vector of real numbers which encodes meaningful semantic information. In this disclosure, “embedding vectors” have the same meaning as sentence embedding. “Embedding computation” means computation of embedding vectors. Embedding vectors may be computed based on special type of LLMs, which are called sentence transformers (e.g., NV-Embed-v2, bge-en-icl, stella_en_1.5B_v5, SFR-Embedding-2_R, gte-Qwen2-7B-instruct, etc.). The best models can be found in massive text embedding benchmark (MTEB) leaderboard. Alternatively, embedding vectors can be built based on different principles as stated in the following: An alternative direction is to aggregate word embeddings, such as those returned by Word2vec, into sentence embeddings. The most straightforward approach is to simply compute the average of word vectors, known as continuous bag-of-words (CBOW). However, more elaborate solutions based on word vector quantization have also been proposed. One such approach is the vector of locally aggregated word embeddings (VLAWE), which demonstrated performance improvements in downstream text classification tasks.

The comparator 150 may compare each of the second vectors with the first vectors to find a closest first vector, and generate a similarity metric between each of the second vectors and the closest first vector. The classifier 160 may classify each of the parts from the second version of the technical document based on the similarity metric and text values of the parts from the second version.

In some embodiments, the comparator 150 may process the embedding vectors from the storage 140 to determine the class of each atomic part of the newer Document v. y. Two stages of operations may be performed on each embedding vector E_{y} of the newer version of the document.

In a first stage, the comparator 150 may compare each vector E_{y} to the vectors Eₓ of required characteristic. Through this comparison, the vectors Eₓ closest to the vectors E_{y} may be found. To find the required vectors, the algorithm for finding the closets vectors is used (e.g., Approximate nearest neighbor may be used). Alternatively, k-nearest neighbors, nearest neighbor distance ratio, fixed-radius near neighbors and similar algorithms can be also used. The nearest neighbor search algorithms require a similarity metric to compare the vectors during the search procedure. Cosine similarity may be used as similarity metrics. However, another similarity metrics can be also used (e.g., Euclidean, Manhattan, Minkowski, etc.) Based on the chosen similarity metric type, the closest vector gets a similarity metric value S which is the real number from 0 to 1. The similarity metric S may be compared to a threshold value Th which is the real number from 0 to 1.

If the value of the similarity metric is one, i.e., S=1, the vector Ey can be classified as “exact match” (class 0, T=0). If the value of the similarity metric S is greater than the threshold value Th and less than 1, the vector E_{y} can be classified as “good match” (class 1, T=1). These two classes can be determined without using the classifier 160 per se, but can be used as an additional data feature during the training of the classifier 160.

If the value of S is less than the threshold value Th, a second stage is initiated. In the second sage, the classifier 160 may determine the type of the vector E_{y} as the one having required characteristic (class 2, T=2) or as the one without the required characteristic (class 3, T=3).

As a result, all the atomic parts of the newer version of the document (i.e., the Document v. y) are classified into the four types. Class 1 (T=1) can be used to show the editing differences between the required characteristics in the older and newer versions of the document. The quality of the required characteristic detection depends on the classifier accuracy as it may perform worse on parts of the document that the classifier has not been trained on. Over time, the quality of the classifier improves by using large amounts of diverse data extracted from different technical documents for further training.

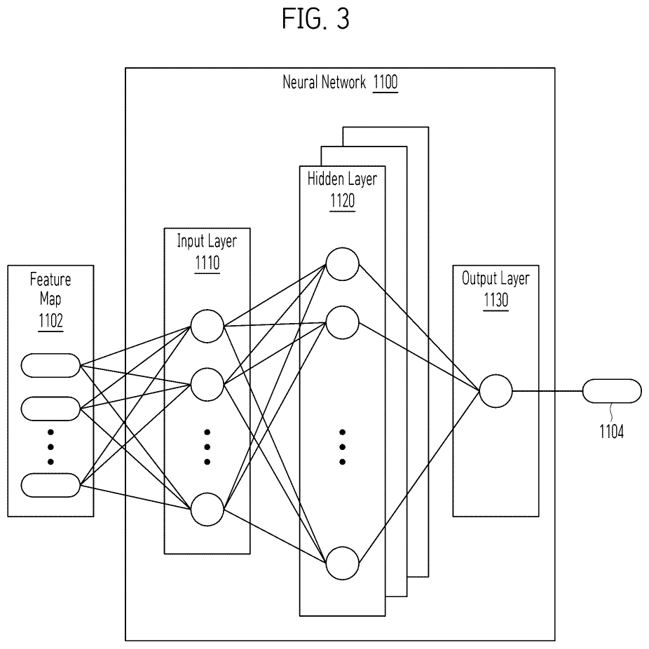

FIG. 3 is a diagram of a neural network 1100 in accordance with one embodiment of the present invention. The neural network 1100 may be implemented for the classifiers 110, 160 and the LLM 130.

Referring to FIG. 3, a feature map 1102 associated with one or more input conditions may input to the neural network 1100. The feature map 1102 includes one or more features associated with one or more input conditions. The neural network 1100 uses the feature map 1102 to generate and output information 1104. As illustrated, the neural network 1100 includes an input layer 1110, one or more hidden layers 1120 and an output layer 1130. Features from the feature map 1102 may be connected to input nodes in the input layer 1110. The information 1104 may be generated from an output node of the output layer 1130. One or more hidden layers 1120 may exist between the input layer 1110 and the output layer 1130. The neural network 1100 may be pre-trained to process the features from the feature map 1102 through the different layers 1110, 1120, and 1130 in order to output the information 1104.

The neural network 1100 may be a multi-layer neural network that represents a network of interconnected nodes, such as an artificial deep neural network, where knowledge about the nodes (e.g., information about specific features represented by the nodes) is shared across layers and knowledge specific to each layer is also retained. Each node represents a piece of information. Knowledge may be exchanged between nodes through node-to-node interconnections. Input to the neural network 1100 may activate a set of nodes. In turn, this set of nodes may activate other nodes, thereby propagating knowledge about the input. This activation process may be repeated across other nodes until nodes in the output layer 1130 are selected and activated.

In one embodiment, the neural network 1100 may include a hierarchy of layers representing a hierarchy of nodes interconnected in a feed-forward way. The input layer 1110 may exist at the lowest hierarchy level. The input layer 1110 as detailed below may include a set of nodes that are referred to herein as input nodes (e.g., the older Document v.x, the required characteristics, the newer Document v.y, the similarity metric or metric value S, the vector E_{y} in FIG. 2). When the feature map 1102 is input to the neural network 1100, each of the input nodes of the input layer 1110 may be connected to each feature of the feature map 1102. Each of the connections may have a weight, each of which is derived from the training of the neural network 1100. The weights represent one set of parameters of the neural network 1100. The input nodes may transform the features by applying an activation function to these features. The information derived from the transformation may be passed to the nodes at a higher level of the hierarchy.

The output layer 1130 may exist at the highest hierarchy level. The output layer 1130 may include one or more output nodes. When the output layer 1130 outputs the output information 1104, each output node may provide a specific value of the output information 1104 (e.g., the required characteristics from the classifier 110, the vector E from the LLM 130, the type T from the classifier 110 in FIG. 2). The number of output nodes depends on how many specific values of output information 1104 are needed. In other words, there can be a one-to-one relationship or mapping between the number of output nodes and the number of values or pieces of output information 1104.

The hidden layer(s) 1120 may exist between the input layer 1110 and the output layer 1130. There may be L hidden layer(s) 1120, where “L” is an integer greater than or equal to one. Each of the hidden layers 1120 may include a set of nodes that are referred to herein as hidden nodes. Example hidden layers may include up-sampling, convolutional, fully connected layers, embedding, attention, normalization and/or data transformation layers. That is, in this disclosure, the neural network is most likely implemented as LLM which include such layers as embedding, attention and normalization. However, the neural network can be also implemented as fully-connected neural network.

At the lowest level of the hidden layer(s) 1120, hidden nodes of that layer may be interconnected to the input nodes. At the highest level of the hidden layer(s) 1120, hidden nodes of that level may be interconnected to the output node. The input nodes may be not directly interconnected to the output node(s). If multiple hidden layers exist, the input nodes are interconnected to hidden nodes of the lowest hidden layer. In turn, these hidden nodes are interconnected to the hidden nodes of the next hidden layer. An interconnection may represent a piece of information learned about the two interconnected nodes. The interconnection may have a numeric weight that can be tuned (e.g., based on a training dataset), rendering the neural network 1100 adaptive to inputs and capable of learning.

Generally, the hidden layer(s) 1120 may allow knowledge about the input nodes of the input layer 1110 to be shared among the output nodes of the output layer 1130. To do so, a transformation ƒ may be applied to the input nodes through the hidden layer 1120. In an example, the transformation ƒ is non-linear. Different non-linear transformations ƒ are available including, for instance, a rectifier function ƒ(x)=max(0,x). In an example, a particular non-linear transformation ƒ is selected based on cross-validation.

### EXAMPLES

The technical documents analysis and management scheme described above has been tested on M-PHY specification versions 4.1 and 6.0. M-PHY is a physical layer interface designed for high speed data communication. The older version of the document (v. 4.1) has 770 atomic parts (e.g., sentences) containing required characteristic (e.g., requirements). The newer version of the document (v. 6.0) has 4515 atomic parts, 1247 of the atomic parts have the required characteristic(s). These documents have been manually processed by the verification engineers as a part of the hardware design verification process.

The atomic parts from both documents have been processed using Sentence Transformers library with the “SFR-Embedding-Mistral” LLM (i.e., the LLM 130) to obtain the embedding vectors.

The embedding comparison algorithms (i.e., the comparator 150) have been implemented in three ways using commercially sourced algorithms: Qdrant vector database, embedded semantic search from Sentence Transformers, and Levenshtein distance based algorithm. The Levenshtein distance based algorithm does not require an embedding vector and can be applied directly to strings. The threshold value Th is set to 0.9 for all algorithms.

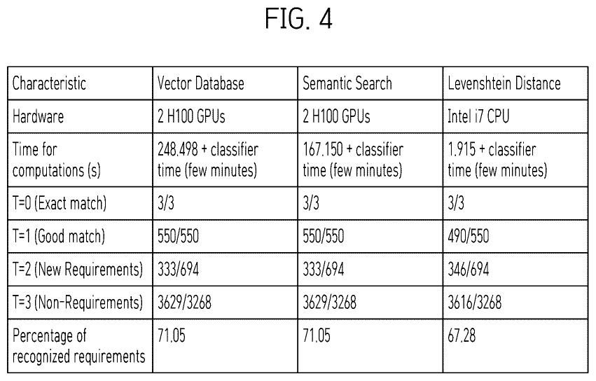

The classifier 160 has been implemented as an ensemble model combining 15 Mistral v. 0.1 LLMs. The results of the experiment are summarized in FIG. 4.

Referring to FIG. 4, the Qdrant vector database and embedded semantic search approaches provide almost the same results as these approaches are based on the same principles and the slight differences in their performance can be explained by a relatively small amount of data, which is more efficiently processed by the semantic search algorithm.

The Levenshtein distance based algorithm has missed 47 requirements because string comparison does not take into account the semantic of the compared strings. For example, algorithms based on vector database and semantic search found 3 (T=0)+550 (T=1)+333 (T=2)=886 requirements. The Levenshtein distance algorithm found 3 (T=0)+490 (T=1)+346 (T=2)=839 requirements. 886−839=47 requirements, i.e., that the Levenshtein distance algorithm missed 47 requirements comparing to the vector database and semantic search algorithms. The results of the string comparison algorithm would be worse if the amount of data were greater. However, if the computational resources are limited, this algorithm can be considered as an alternative. In this case, limited resources mean that only CPU (Central Processing Unit) is available for computations. The Levenshtein distance algorithm can operate with limited resources, but the other algorithms require GPU (Graphics Processing Unit) for embedding computation. If vector database and semantic search algorithms are run on limited resources (without GPU), the performance will drop significantly (at least 10 times depending on type of CPU available).

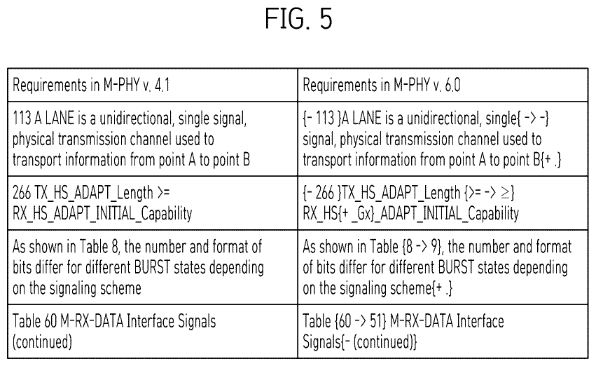

Some of the examples of the “good match” requirements (T=1) are shown in FIG. 5.

Referring to FIG. 5, there are the “good match” (i.e., Type 1 (Class 1)) requirements between M-PHY specification versions 4.1 and 6.0. The difference between sentences is shown in curly brackets ({}), i.e., the parts with minus sign (e.g., {−113}) mean that this part (string “113”) has been removed from the older version of the sentence; the parts with plus sign (e.g., {+.}) mean that this part (string “.”) has been added to the older version of the sentence.

The overall performance of technical documents analysis and management scheme described above can be improved by training a classifier on larger amounts of data, e.g., tens or hundreds of thousand data points.

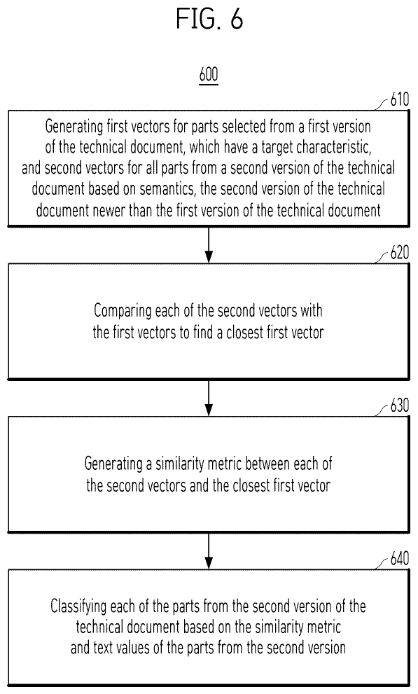

FIG. 6 is a flowchart illustrating a method 600 for analyzing and managing a technical document in accordance with one embodiment of the present invention. The method 600 may be performed by the documents analysis system 100 of FIG. 2.

Referring to FIG. 6, at operation 610, the method 600 may generate first vectors for parts selected from a first version of the technical document, which have a target characteristic, and second vectors for all parts from a second version of the technical document based on semantics. The second version of the technical document may be newer than the first version of the technical document.

Operation 620 may include comparing each of the second vectors with the first vectors to find a closest first vector.

Operation 630 may include generating a similarity metric between each of the second vectors and the closest first vector.

Operation 640 may include classifying each of the parts from the second version of the technical document based on the similarity metric and text values of the parts from the second version.

In some embodiments, the technical document includes at least one or more of a specification, a manual, a user guide and a standard, which are each associated with the storage device.

In some embodiments, the target characteristic includes at least one or more of design requirements, algorithms, test sequences, and particular parameters.

In some embodiments, each part from the first and second versions of the technical document includes at least one or more of sentences, paragraphs, sections, and chapters of the technical document.

In some embodiments, the classifying each of the parts from the second version of the technical document includes: classifying a corresponding part from the second version of the technical document as a first class when the similarity metric indicates that each second vector is the same as the closest first vector, and classifying a corresponding part from the second version of the technical document as a second class when the similarity metric is greater than a threshold value.

In some embodiments, the classifying each of the parts from the second version of the technical document further includes: determining whether a corresponding part from the second version of the technical document has the target characteristic when the similarity metric is less than or equal to the threshold value.

In some embodiments, the classifying each of the parts from the second version of the technical document further includes: classifying the corresponding part from the second version of the technical document as a third class when the similarity metric is less than or equal to the threshold value and the corresponding part from the second version of the technical document has the target characteristic, and classifying the corresponding part from the second version of the technical document as a fourth class when the similarity metric is less than or equal to the threshold value and the corresponding part from the second version of the technical document does not have the target characteristic.

In some embodiments, each of the first and the second vectors includes an embedding vector.

In some embodiments, the method 600 further includes: storing, in a storage, the first vectors and the second vectors.

In some embodiments, the method 600 further includes: determining whether each of all parts from the first version of the technical document has the target characteristic.

As described above, embodiments of the present invention provide a scheme for analyzing and managing technical documents for a storage device based on large language models. This scheme can work with the technical documents in an efficient way, i.e., to decrease the time required for the processing of the new version of the document.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives. Furthermore, the embodiments may be combined to form additional embodiments.

1. A system for managing a technical document for a storage device, the system comprising:
a large language model (LLM), implemented by at least one processor, configured to receive parts selected from a first version of the technical document, which have a target characteristic, and parts from a second version of the technical document newer than the first version of the technical document, and generate first vectors for the selected parts from the first version of the technical document and second vectors for the received parts from the second version of the technical document based on semantics;
a comparator, implemented by the at least one processor, configured to compare each of the second vectors with the first vectors to find a closest first vector, and generate a similarity metric between each of the second vectors and the closest first vector; and
a classifier, implemented by the at least one processor, configured to classify each of the parts from the second version of the technical document based on the similarity metric and text values of the parts from the second version, and analyze a remaining part of the second version of the technical document to detect at least one new required characteristic.

2. The system of claim 1, wherein the technical document includes at least one or more of a specification, a manual, a user guide and a standard, which are each associated with the storage device.

3. The system of claim 2, wherein the target characteristic includes at least one or more of design requirements, algorithms, test sequences, and particular parameters.

4. The system of claim 2, wherein each part from the first and second versions of the technical document includes at least one or more of sentences, paragraphs, sections, and chapters of the technical document.

5. The system of claim 1, wherein:
when the similarity metric indicates that each second vector is the same as the closest first vector, the classifier classifies a corresponding part from the second version of the technical document as a first class, and
when the similarity metric is greater than a threshold value, the classifier classifies a corresponding part from the second version of the technical document as a second class.

6. The system of claim 5, wherein:
when the similarity metric is less than or equal to the threshold value, the classifier is further configured to determine whether a corresponding part from the second version of the technical document has the target characteristic.

7. The system of claim 6, wherein:
when the similarity metric is less than or equal to the threshold value and the corresponding part from the second version of the technical document has the target characteristic, the classifier classifies the corresponding part from the second version of the technical document as a third class, and
when the similarity metric is less than or equal to the threshold value and the corresponding part from the second version of the technical document does not have the target characteristic, the classifier classifies the corresponding part from the second version of the technical document as a fourth class.

8. The system of claim 1, wherein each of the first and the second vectors includes an embedding vector.

9. The system of claim 1, further comprising:
a storage configured to store the first vectors and the second vectors.

10. The system of claim 1, further comprising:
an additional classifier configured to determine whether each of the received parts from the first version of the technical document has the target characteristic.

11. A method for managing a technical document for a storage device, the method comprising:
generating, by an LLM implemented by a processor, first vectors for parts selected from a first version of the technical document, which have a target characteristic, and second vectors for parts received from a second version of the technical document based on semantics, the second version of the technical document newer than the first version of the technical document;
comparing each of the second vectors with the first vectors to find a closest first vector;
generating a similarity metric between each of the second vectors and the closest first vector; and
classifying each of the parts from the second version of the technical document based on the similarity metric and text values of the parts from the second version, and analyzing a remaining part of the second version of the technical document to detect at least one new required characteristic.

12. The method of claim 11, wherein the technical document includes at least one or more of a specification, a manual, a user guide and a standard, which are each associated with the storage device.

13. The method of claim 12, wherein the target characteristic includes at least one or more of design requirements, algorithms, test sequences, and particular parameters.

14. The method of claim 12, wherein each part from the first and second versions of the technical document includes at least one or more of sentences, paragraphs, sections, and chapters of the technical document.

15. The method of claim 11, wherein the classifying each of the parts from the second version of the technical document includes:
classifying a corresponding part from the second version of the technical document as a first class when the similarity metric indicates that each second vector is the same as the closest first vector, and
classifying a corresponding part from the second version of the technical document as a second class when the similarity metric is greater than a threshold value.

16. The method of claim 15, wherein the classifying each of the parts from the second version of the technical document further includes:
determining whether a corresponding part from the second version of the technical document has the target characteristic when the similarity metric is less than or equal to the threshold value.

17. The method of claim 16, wherein the classifying each of the parts from the second version of the technical document further includes:
classifying the corresponding part from the second version of the technical document as a third class when the similarity metric is less than or equal to the threshold value and the corresponding part from the second version of the technical document has the target characteristic, and
classifying the corresponding part from the second version of the technical document as a fourth class when the similarity metric is less than or equal to the threshold value and the corresponding part from the second version of the technical document does not have the target characteristic.

18. The method of claim 11, wherein each of the first and the second vectors includes an embedding vector.

19. The method of claim 11, further comprising:
storing, in a storage, the first vectors and the second vectors.

20. The method of claim 11, further comprising:
determining whether each of the received parts from the first version of the technical document has the target characteristic.
